(19) United States
(12) Patent Application Publication
(10) Pub. No.: US 2012/0034951 A1
(43) Pub. Date: Feb. 9, 2012

(54) CRADLE FOR EXTENDING DATA CAPABILITIES TO A WIRELESS DEVICE

(75) Inventors: JOHN M. JONES, III, OVERLAND PARK, KS (US); BRANDON C. ANNAN, WESTWOOD HILLS, KS (US); THOMAS W. KEEL, LEES SUMMIT, MO (US); KEVIN PACKINGHAM, OVERLAND PARK, KS (US)

(73) Assignee: SPRINT COMMUNICATIONS COMPANY L.P., OVERLAND PARK, KS (US)

(21) Appl. No.: 12/893,549

(22) Filed: Sep. 29, 2010

Related U.S. Application Data
(60) Provisional application No. 61/371,988, filed on Aug. 9, 2010.

(51) Int. Cl. H04M 1/00

(52) U.S. Cl. 455/556.1

(57) ABSTRACT

The invention is directed to a cradle that extends a wireless device's ability to communicate data through a wireless communications network. The cradle includes a frame having back, side, and bottom portions that define an open space for receiving a wireless device that has the ability to communicate with a wireless local area network using, for example, Wi-Fi technology. The wireless device is held in place relative to the frame so that the wireless device remains in direct contact with the cradle. At least one wireless communication component is integrated into the cradle to facilitate communication of data between the wireless device and the wireless communications network.

### CROSS REFERENCE TO RELATED APPLICATIONS

This application claims the benefit of, and expressly incorporates by reference, U.S. Provisional Application No. 61/371,988, filed on Aug. 9, 2010.

### SUMMARY

Embodiments of the invention are defined by the claims below, not this summary. A high-level overview of various aspects of the invention are provided here for that reason, to provide an overview of the disclosure, and to introduce a selection of concepts that are further described below in the detailed-description section below. This summary is not intended to identify key features or essential features of the claimed subject matter, nor is it intended to be used as an aid in isolation to determine the scope of the claimed subject matter.

In brief and at a high level, this disclosure describes, among other things, a cradle that receives a wireless device and that extends the wireless device's capabilities to access a wireless communications network. A wireless device, as used herein, is a device that has the ability to communicate with a wireless local area network (WLAN) using a wireless communication technology such as 802.11 or any other available Wi-Fi technology. The cradle is able to transfer data to the wireless device and receive data from the wireless device. The cradle is further able to wirelessly communicate with a wireless communications network using a wireless technology such as CDMA, GPRS, TDMA, GSM, WIMAX, LTE, 3G, 4G, etc. In one embodiment, the cradle is in direct contact with the wireless device such that the wireless device is held in place by the cradle and remains in position relative to the cradle until it is removed. In this embodiment, the cradle and wireless device wirelessly communicate data between each other. To wirelessly communicate data, the cradle is equipped with a short-range wireless communication component to facility communication with the wireless device. The cradle additionally has a long-range wireless communication component that facilitates wireless communication with the wireless communications network. In an alternative embodiment, there is a mechanical and electrical connection between the cradle and the wireless device such that the transfer of data between the cradle and wireless device is not wireless, but instead by way of a physical connection. In this embodiment, the cradle may include a long-range wireless communication component to wireless communicate data and other information with the wireless communications network, but may not include a short-range wireless communication component.

### BRIEF DESCRIPTION OF THE SEVERAL VIEWS OF THE DRAWINGS

Illustrative embodiments of the present invention are described in detail below with reference to the attached drawing figures, wherein:

FIG. 1 depicts an illustrative device suitable for use in connection with an embodiment of the present invention;

FIG. 2 depicts an illustrative operating system suitable for practicing an embodiment of the present invention;

FIGS. 3A and 3B depict perspective views of a cradle for receiving a wireless device, in accordance with embodiments of the present invention;

FIG. 4 depicts a front view of a cradle for receiving a wireless device, in accordance with an embodiment of the present invention;

FIGS. 5 and 6 depict side views of a cradle for receiving a wireless device, in accordance with embodiments of the present invention;

FIG. 7 depicts a rear view of a cradle for receiving a wireless device, in accordance with an embodiment of the present invention;

FIG. 8 depicts a bottom view of a cradle for receiving a wireless device, in accordance with an embodiment of the present invention;

FIG. 9 depicts a top view of a cradle for receiving a wireless device, in accordance with an embodiment of the present invention;

FIG. 10 depicts a cutaway view of a cradle for receiving a wireless device, in accordance with an embodiment of the present invention;

FIG. 11 depicts a front view of a cradle for receiving a wireless device, in accordance with an embodiment of the present invention;

FIG. 12 depicts a side view of a cradle for receiving a wireless device, in accordance with an embodiment of the present invention;

FIG. 13 depicts a bottom view of a cradle for receiving a wireless device, in accordance with an embodiment of the present invention;

FIG. 14 depicts a rear view of a cradle that provides voice services, in accordance with an embodiment of the present invention; and

FIGS. 15A and 15B depict interfaces of a wireless device, in accordance with embodiments of the present invention.

### DETAILED DESCRIPTION

The subject matter of the present invention is described with specificity herein to meet statutory requirements. However, the description itself is not intended to define the invention, which is what the claims do. Rather, the claimed subject matter might be embodied in other ways to include different steps or combinations of steps similar to the ones described in this document, in conjunction with other present or future technologies. Moreover, although the term “step” or other generic term might be used herein to connote different components or methods employed, the terms should not be interpreted as implying any particular order among or between various steps herein disclosed unless and except when the order of individual steps is explicitly described.

Throughout this disclosure, several acronyms and shorthand notations are used to aid the understanding of certain concepts pertaining to the associated system and services. These acronyms and shorthand notations are solely intended for the purpose of providing an easy methodology of communicating the ideas expressed herein and are in no way meant to limit the scope of the present invention. The following is a list of these acronyms:
BSC Base Station Controller
BTS Base Transceiver Station
CDMA Code Division Multiple Access
FA Foreign Agent
GPRS General Packet Radio Service
GPS Global Positioning System
GSM Global System for Mobile communications (Groupe Spécial Mobile)
HA Home Agent
LCD Liquid Crystal Display
LED Light Emitting Diode
LTE Long Term Evolution
PDA Personal Data Assistant
PDSN Packet Data Serving Node
TDMA Time Division Multiple Access
USB Universal Serial Bus
VOIP Voice Over Internet Protocol
WLAN Wireless Local Area Network

Further, various technical terms are used throughout this description. An illustrative resource that fleshes out various aspects of these terms can be found in Newton's Telecom Dictionary, 25th Edition (2009).

Embodiments of the technology may take the form of, among other things: a method, system, or set of instructions embodied on one or more computer-readable media. Computer-readable media include both volatile and nonvolatile media, removable and nonremovable media, and contemplate media readable by a database, a switch, and various other network devices. By way of example, and not limitation, computer-readable media comprise media implemented in any method or technology for storing information. Examples of stored information include computer-useable instructions, data structures, program modules, and other data representations. Media examples include, but are not limited to information-delivery media, RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data momentarily, temporarily, or permanently.

As mentioned, embodiments of the present invention are directed to a cradle that is shaped to receive a wireless device, and that extends the wireless device's ability to communicate data. In embodiments, the cradle may even provide voice and GPS services to the wireless device. The cradle has a short-range wireless communication component (e.g., short-range radio) and/or a long-range communication component (e.g., long-range radio). These wireless communication components transfer data using various communication standards and protocols. In one instance, the cradle has only a long-range wireless communication component as the wireless device and cradle have a mechanical and electrical connection that allows the wireless device to be physically connected such that a short-range wireless communication component is not needed. In an alternative embodiment, however, the wireless device and cradle are in direct contact with one another, but data is communicated wirelessly such that the cradle has both a short-range and long-range wireless communication component.

The cradle, in one instance, may function as a mobile telecommunications device and may be capable of functioning on its own without the wireless device, although the wireless device may still be in physical contact with the cradle. Alternatively, the cradle may pass audio and data through the cradle to the wireless device so that audio can be heard through the wireless device, not through the cradle. In yet another embodiment, software is installed on the wireless device that enables voice services on the wireless device, such as VOIP or Skype®, which is a registered trademark of Skype Limited Corporation Ireland located at Arthur Cox Building Earlsfort Terrace, Dublin 2 Ireland. In these instances, a microphone, if not already incorporated into the wireless device may be required.

In one aspect of the present invention, a cradle is provided for receiving a wireless device. The cradle enables the wireless device to communicate with a wireless communications network. The cradle includes a frame comprising a back portion, side portions, and a bottom portion onto which a bottom end of the wireless device is placed. The back portion, the side portions, and the bottom portion define an open space that receives the wireless device such that when the wireless device is placed into the open space, the wireless device stays in place relative to the frame thus remaining in direct contact with the cradle. The cradle further includes a first wireless communication component that facilitates wireless communication between the wireless device.

In a further aspect of the present invention, a cradle is provided for receiving a wireless device, the cradle enabling the wireless device to communicate with a wireless communications network. The cradle includes a frame comprising a back portion, side portions, and a bottom portion comprising a connector element for engaging a bottom connector of the wireless device such that the cradle and the wireless device are mechanically and electrically connected thus enabling communication between the cradle and the wireless device. The back portion, the side portions, and the bottom portion of the frame define an open space for receiving the wireless device. The cradle further includes a wireless communication component that facilitates long-range signaling between the cradle and the wireless communications network.

In yet another aspect of the present invention, a cradle is provided for receiving a wireless device, the cradle enabling the wireless device to communicate with a wireless communications network. The cradle includes a frame comprising a back portion, left and right side portions, and a bottom portion. The back portion, the left and right side portions, and the bottom portion define a space into which the wireless device is received such that the wireless device is held in place relative to the cradle and remains in close proximity to the cradle until the wireless device is removed from the cradle. Further, the cradle includes a first wireless connection component that facilitates short-range signaling between the wireless device and the cradle such that data is communicated between the wireless device and the cradle by way of the first wireless connection component. The cradle additionally includes a second wireless connection component that facilitates long-range signaling between the cradle and the wireless communications network such that the data is communicated from the cradle to the wireless communications component by way of the second wireless connection component.

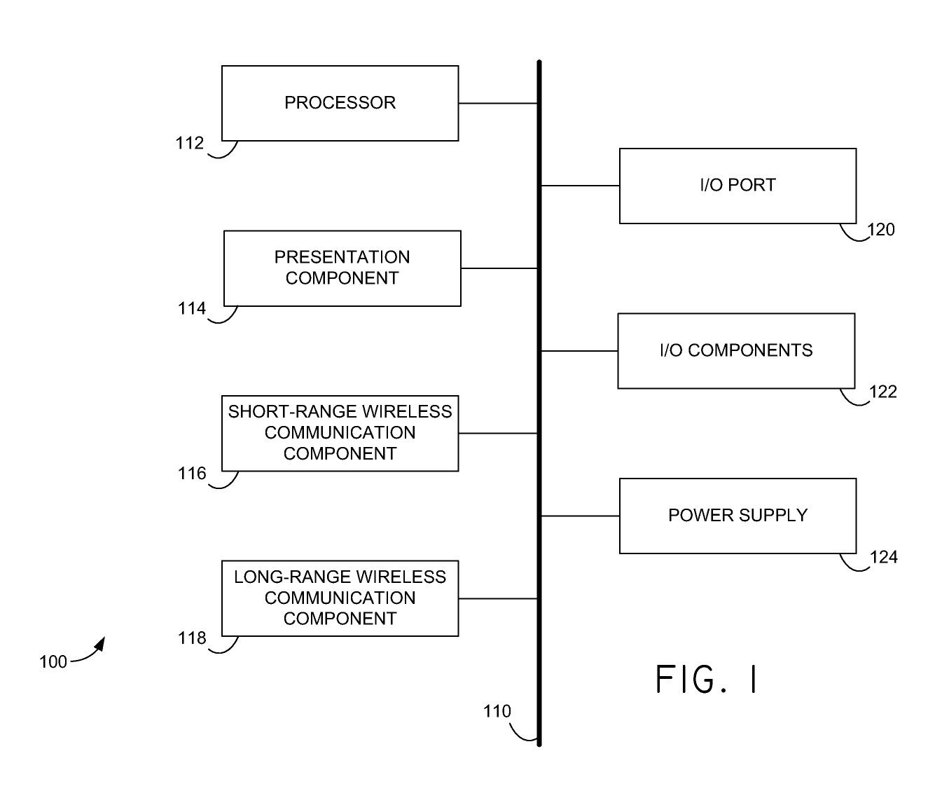

Turning now to FIG. 1, a block diagram of an illustrative cradle device (“cradle”) is provided and referenced generally by the numeral 100. Although some components are shown in the singular, they may be plural. For example, cradle 100 might include multiple processors or multiple radios, etc. As illustratively shown, cradle 100 includes a bus 110 that directly or indirectly couples various components together including a processor 112, a presentation component 114, a short-range wireless communication component 116, a long-range wireless communication component 118, input/output ports 120, input/output components 122, and a power supply 124. Various components listed above may not be required in each embodiment of the present invention as described herein, and thus although illustrated in FIG. 1, it is contemplated that not all will be required. Alternatively, other components other than those illustrated in FIG. 1 may be incorporated into a cradle 100.

Processor 112 might actually be multiple processors that receive instructions and process them accordingly. Presentation component 114 includes the likes of a display, a speaker, as well as other components that can present information (such as a lamp (LED), or even lighted keyboards). In an exemplary embodiment, the cradle 100 includes a speaker that outputs audio from a wireless device that is physically connected to the cradle 100. The speaker allows a user to hear audio transferred from the wireless device. In an alternate embodiment, the cradle 100 may have a display, such as an LCD screen. In this embodiment, the cradle 100 may actually function like a mobile phone in that it is able to make and receive telephone calls, thus communicating with a wireless telecommunications network. This embodiment is shown in further detail in FIG. 14.

In embodiments, the cradle 100 has two separate wireless communications components, such as radios, to facilitate both short-range and long-range signaling. Short-range wireless communication component 116 allows short-range signals to be communicated between the cradle 100 and the wireless device with which the cradle 100 is in direct contact. Short-range signals may be communicated through a wireless local area network (WLAN) using Wi-Fi technology, for example. Various wireless protocols and standards may be used to communicate short-range signals, such as 802.11a, 802.11b, 802.11g, 802.11n, etc. Short-range signaling, as used herein, does not include wireless communication technologies that are used for communication with a base transceiver station (BTS) or other type of cell tower, such as CDMA, GPRS, TDMA, GSM, WIMAX, LTE, 3G, 4G, etc. These wireless communication technologies will be discussed further herein in relation to long-range signaling.

Long-range wireless communication component 118 facilitates communication, such as long-range signaling, between the cradle 100 and the wireless communications network, or more specifically, between the cradle 100 and the BTS. Illustrative wireless communications technologies include CDMA, GPRS, TDMA, GSM, WIMAX, LTE, 3G, 4G, and the like. In one embodiment, the cradle 100 has one wireless communication component, such as a radio, that facilitates both short-range and long-range wireless communications.

Input/output ports 120 might take on a variety of forms. Illustrative input/output ports include a USB port, a mini USB port, a micro USB port, stereo jack, infrared port, proprietary communications ports, and the like. Cradle 100, in one embodiment, includes a headphone jack and a USB port, such as a mini USB port. Input/output components 122 include items such as keyboards, microphones, touch screens, and any other item usable to directly or indirectly input data into cradle 100. In one embodiment, cradle 100 is used as a mobile phone, or aids the wireless device so that the wireless device can be used as a mobile phone. The cradle 100 may have a keyboard allowing the user to input telephone numbers or other text. The cradle 100 may also have a microphone allowing the user to transfer audio through the wireless device or through the cradle 100.

Power supply 124 includes items such as batteries, fuel cells, or any other component that can act as a power source to provide power to cradle 100. In one embodiment, the cradle 100 has a battery. Here, the power resources from the battery may be shared with the wireless device such that the cradle 100 powers or at least partially powers the wireless device. In another embodiment, the cradle 100 does not power itself, but instead is powered and receives power resources from the wireless device to which the cradle 100 is physically connected.

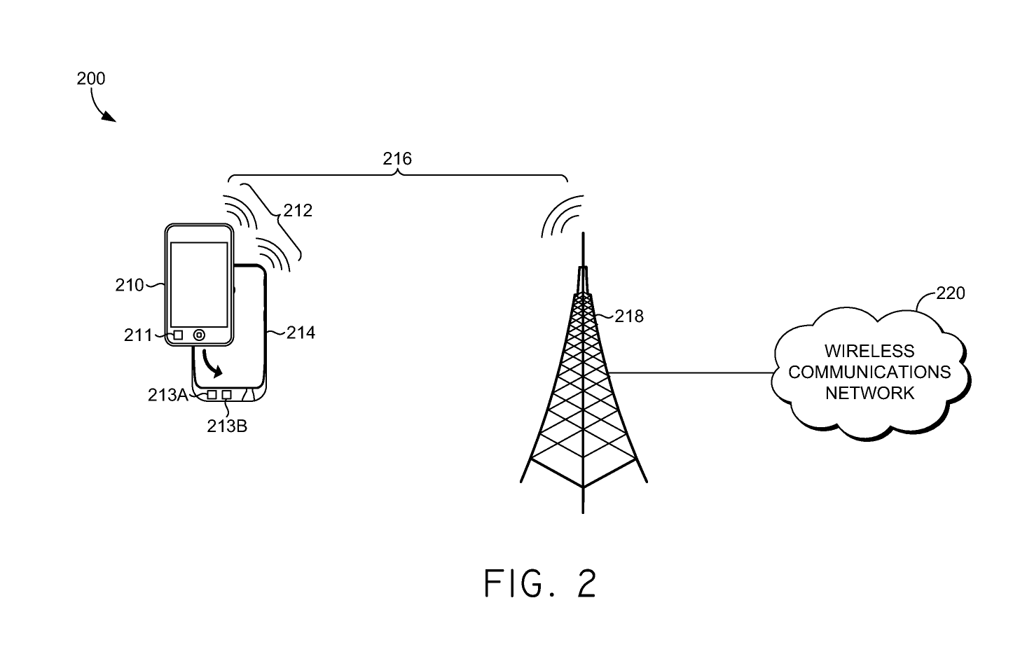

Turning now to FIG. 2, an illustrative operating environment is provided and referenced generally by the numeral 200, which depicts an illustrative networking environment that enables a cradle to facilitate communication between a wireless device and a wireless communications network. Illustrated in the embodiment of FIG. 2 is a wireless device 210, a cradle 214, a BTS 218, and a wireless communications network 220. Wireless device 210 may be any type of wireless device that has a wireless communications component for communicating short-range signals. In one embodiment, the wireless device 210 is a Wi-Fi-capable device. Exemplary wireless devices include MP3 players or other personal music-playing devices, personal data assistants (PDAs), mobile telecommunication devices, GPS devices, cameras, video cameras, security cameras, slate computers or other personal computing devices, scanning devices, personal medical devices (e.g., insulin tracking devices), inventory tracking devices, or the like. In one embodiment, the wireless device is an iPod Touch®, which is a registered trademark owned by Apple Inc., whose address is 1 Infinite Loop, Cupertino, Calif. 95014. The wireless device 210 is shown having a short-range wireless communication component 211 (e.g., radio) that enables the wireless device 210 to wirelessly communicate with a wireless local area network (WLAN).

The cradle 214, in one embodiment, is a device such as cradle 100 described herein in relation to FIG. 1. The cradle 214 receives the wireless device 210 into an open space defined by the frame of the cradle 214 such that the wireless device 210 is physically connected to the cradle. The wireless device 210 remains in place relative to the cradle 214 until the wireless device 210 is removed from the cradle 214. The close proximity of the cradle 214 in relation to the wireless device 210 after the cradle 214 has received the wireless device 210 allows for a shorter distance for short-range signals to travel when being communicated between the wireless device 210 and the cradle 214. Even further, as the wireless device 210 and the cradle 214 are in physical contact with each other, this amount of close proximity may even provide a higher signal strength. As mentioned, the cradle 214 enables the wireless device 210 to communicate with the wireless communications network 220. Thus, the cradle 214, as shown, has a short-range wireless communication component 213A for communicating data and other information with the wireless device 210, and a long-range wireless communication component 213B for communicating data and other information with a wireless communications network. In one instance, the cradle 214 allows the wireless device 210 to communicate data through the wireless communications network 220. In another instance, the cradle 214 provides voice services to the wireless device 210. For example, when voice services are enabled, the cradle 214 may handle the inbound signals and simply pass the audio to the wireless device 210. Or, the cradle 214 may have a speaker that outputs audio from a voice call. Similarly, an application or other type of software may be installed on the wireless device 210 allowing the user of the wireless device 210 to make telephone calls using, for instance, VOIP or Skype®.

Short-range communications link 212 is a short-range connection between the wireless device 210 and the cradle 214. When we refer to “short” and “long” types of connections, we do not mean to refer to the spatial relation between two devices, although in many embodiments of the present invention, the distance between the cradle 214 and the wireless device 210 may be much shorter than the distance between the cradle 214 and the wireless communications network 220 because the cradle 214 is directly in contact with the wireless device 210. Instead, we are generally referring to short range and long range as different categories, or types, of connections (i.e., a primary connection and a secondary connection). A short-range connection may include a Wi-Fi connection to a device (e.g., mobile hotspot), such as the cradle 214. The short-range communications link 212 provides the wireless device 210 with access to a local network, such as a WLAN using 802.11 protocol (e.g., 802.11a, 802.11b, 802.11g, 802.11n) or any other available protocol or communication standard.

Long-range communication link 216 is a long-range connection between the cradle 214 and the wireless communications network 220 by way of the BTS 218. Generally, the BTS 218, along with a base station controller (BSC) (not shown), provides the wireless device 210 with access to the wireless communications network 220. The BSC manages the communication between a number of BTSs, such as BTS 218, and a limited number of devices, such as wireless device 210, that are compatible with the operating environment 200. The long-range connection provided by the long-range communication link 216 may include a connection using one or more of CDMA, GPRS, GSM, TDMA, WIMAX, LTE, 3G, 4G, and 802.16. Other protocols are also contemplated to be within the scope of the present invention, although not specifically mentioned here. The wireless communications network 220 may comprise one or more components that are not illustrated in FIG. 2 so as to not obscure the other components described herein. For instance, the wireless communications network 220 may include components such as a packet data serving node (PDSN), a home agent (HA), a foreign agent (FA), etc.

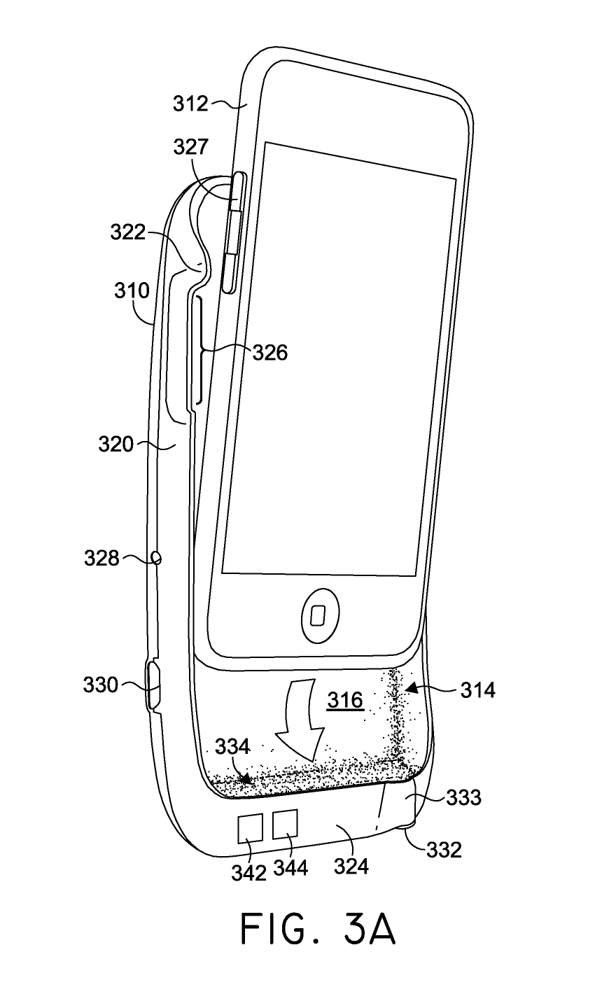

Turning now to FIG. 3A, a perspective view 300 is shown of a cradle for receiving a wireless device. According to embodiments of the present invention, a cradle 310 is provided and is shaped such that it can receive a wireless device 312. When the wireless device 312 is received by the cradle 310, the two devices are in direct physical contact with one another so that at least a portion of the cradle 310 is physically touching at least a portion of the wireless device 312. As previously mentioned, the wireless device 312 may be any type of wireless device that has wireless communication abilities. As used herein, wireless communication abilities refer to the ability to communicate with some type of local network, such as a modem, hotspot, or other WLAN. Here, the cradle 310 is configured to act as a wireless, mobile hotspot that can be easily carried along with the wireless device 312 as the cradle 310 is physically attached to the wireless device 312. In one embodiment, the wireless device 312 is secured to the cradle 310 by way of the pressure caused by the cradle 310 onto the wireless device 312 when the wireless device 312 is received into open space of the cradle 310. For instance, the extended areas shown on the side portions of the cradle may assist in holding the wireless device 312 in place. Alternatively, some type of securing or connecting device may be used to secure the wireless device 312 to the cradle 310.

The cradle has a frame that includes a back portion 314, side portions 320, and a bottom portion 324. The back portion 314 is comprised of an inside back surface 316 and an outside back surface (not shown). The wireless device 312, when placed into the open space of the cradle's frame, comes in physical contact with the inside back surface 316 of the cradle 310, as shown in FIG. 3A. The side portions 320 comprise a left-side portion and a right-side portion, and in the embodiment of FIG. 3A have extended areas 322 (e.g., wings) that extend from the side portions 320. These extended areas 322 may assist in holding the wireless device 312 in place once it is received by the cradle 310. In alternate embodiments, these extended areas 322 may not be present, or may be shaped differently than shown in FIG. 3A. Or, the extended areas 322 may slightly wrap in front of the wireless device 312 when the wireless device 312 is placed into the cradle 310. Just underneath the extended areas 322 may be a receded area that defines an opening for a volume control 327 on the wireless device 312. The volume control opening 326 on the cradle 310 allows for a user to adjust the volume using the volume control 327 on the wireless device 312. The volume control opening 326 on the cradle 310 can be located on a different portion of the cradle 310, but is dependent on the location of the volume control 327 on the wireless device 312. Various ports/jacks/holes are illustrated on the side portion 320, including reset button 328 and USB port 330. While these are shown on the side portion 320 in the embodiment of FIG. 3, it is contemplated to be within the scope of the present invention that these may be located on any portion of the cradle 310.

The frame of the cradle 310 also comprises a bottom portion 324. The bottom end of the wireless device 312 makes physical contact with the top surface of the bottom portion 324. The bottom portion 324 is shown here with a bottom port 332, such as a headphone jack, and a raised bottom portion 333 surrounding the bottom port 332. In the instance that a user of the wireless device 312 wishes to use headphones, the connector on the headphones can be inserted into the bottom port 332. As with the reset button 328 and the USB port 330, the bottom port 332 can also be located on any other portion of the cradle 310, and such variations are contemplated to be within the scope of the present invention. Further, in one embodiment, the reset button 328 and the USB port 330 are connections to the cradle 310, and the connection to the bottom port 332 is a pass-through connection to the wireless device 312 itself such that when headphone connector is inserted into the bottom port 332, it is inserted directly into the wireless device 312 through the opening on the cradle 310. In one embodiment, the USB port 330 is a mini USB port that allows for a charging device to be inserted into the cradle 310 for charging of the battery of the cradle 310.

The back portion 314, the side portions 320, and the bottom portion 324 together define an open space 334 where the wireless device 312 is placed when it is desired that the wireless device 312 be physically connected to the cradle 310. As mentioned, in one embodiment, the wireless device 312 is held in place by way of a pressure fit caused by the frame of the cradle 310. In particular, the side portions 320 may be designed such that when the wireless device 312 is placed into the open space 334 of the cradle 310, the wireless device 312 is held in place so that even when the cradle 310 is moved, the wireless device 312 stays in place relative to the cradle 310.

In addition to the features of the frame described above, the cradle 310 also comprises one or more wireless communication components (e.g., radios) that facilitate wireless communication both between the wireless device 312 and the cradle 310, and between the cradle 310 and a wireless communications network. A short-range wireless communication component 342 and a long-range wireless communication component 344 are illustrated in FIG. 3A. Here, they are both shown as being housed in the bottom portion 324 of the cradle 310, but in other embodiments, may be housed in other portions of the cradle 310, such as in one of the side portions 320. As previously mentioned herein, the short-range wireless communication component 342 facilitates communication between the wireless device 312 and the cradle 310 by wirelessly communicating data, voice, etc., from the cradle 310 to the wireless device 312, and by wirelessly receiving data, voice, etc., from the wireless device 312 to the cradle 310. The wireless device 312 is a Wi-Fi enabled device that is able to connect to the Internet when it is within range (e.g., physically connected to the cradle 310) of a wireless network (e.g., the cradle 310) that is connected to the Internet. As such, the cradle 310 provides the wireless device 312 with a mobile hotspot, or an access point, so that the wireless device 312 is able to connect to the Internet without the need of being within range of another wireless hotspot. The wireless device 312 is also equipped with a wireless communication component that allows it to send and receive data and other media to and from the cradle 310.

The short-range wireless communication component 342 may facilitate wireless communication using Wi-Fi. Wi-Fi, as used herein, is a type of wireless communication between a Wi-Fi enabled device and a wireless local area network (WLAN) based on the IEEE 802.11 standards, which, today, is the most used WLAN class. Exemplary Wi-Fi standards that are typically used today include 802.11a, 802.11b, 802.11g, and 802.11n. This is not an exhaustive list of standards that can be used for communication between the wireless device 312 and the cradle 310, but rather is provided for exemplary purposes. As such, other standards and communication protocols are also contemplated to be within the scope of the present invention.

The cradle 310 also includes a long-range wireless communication component 344 that facilitates wireless communication between the cradle 310 and a wireless communications network. As such, data is transferred between the cradle 310 and a wireless communications network via the long-range wireless communication component 344. Exemplary communication technologies used by the long-range wireless communication component 344 include CDMA, GPRS, TDMA, GSM, WIMAX, 3G, 4G, and LTE. Others are contemplated to be within the scope of the present invention, although not specifically mentioned herein. Using both the short-range wireless communication component 342 and the long-range wireless communication component 344, data can be communicated from the wireless device 312 to the cradle 310 by way of the short-range wireless communication component 342, and then communicated from the cradle 310 to the wireless communications network by way of the long-range wireless communication component. In one embodiment, a single wireless communication component is required that facilitates both long and short-range signaling.

Further, in addition to the features that the cradle 310 provides that have been discussed here, the cradle 310 may also provide GPS services to allow location-based services to be used for the wireless device 312. For instance, GPS capabilities of the cradle 310 may be able to provide a current location of the wireless device 312 such that map applications, weather applications, and other location-based services can be accessed by the wireless device 312. Additionally, further embodiments include a wireless device that has a camera such that a camera hole is included in the cradle to expose the camera lens in the wireless device. The camera lens and corresponding camera hole in the cradle may be located on the back portion of each device near the top. Even further, embodiments of the present invention may include a microphone on the cradle such that the user can use voice-enabled applications, such as VOIP and Skype® that require a microphone to capture audio associated with the user.

FIG. 3B is an alternate embodiment to the embodiment shown in FIG. 3A. The cradle 310 and the wireless device 312 are shown in FIG. 3B as having similar features as the cradle 310 and wireless device 312 in FIG. 3A, except that here, the cradle 310 has a male connector 338 and the wireless device 312 has a female connector 340. When connected, a mechanical and electrical connection is made such that data is communicated by way of this physical connection instead of the short-range wireless connection described above in reference to FIG. 3A.

As the embodiment of FIG. 3B includes a mechanical and electrical connection between the cradle 310 and the wireless device 312, power resources may be shared between the two devices. For instance, power resources from the cradle 310 may be shared or transferred to the wireless device 312. This may be useful in an instance when the battery life of the cradle 310 is high and the wireless device 312 requires more power resources in order to operate. Here, the two devices can be connected so that the wireless device 312 has enough power resources to properly function. Alternatively, power resources from the wireless device 312 may be transferred to the cradle 310 and used to power the cradle 310. This may be most useful in instances where the wireless device 312 has a particularly long battery life and is able to share power resources but still maintain enough power resources to properly function. The cradle 310 may have a battery that is able to be charged by way of being physically connected to the wireless device 312 as described above and may also be able to be charged in other ways, such as being tethered to a computer or by using a wall charger.

Turning now to FIG. 4, a front view of a cradle for receiving a wireless device is shown, in accordance with an embodiment of the present invention. The back portion 314 includes an inside back surface 316 and an outside back surface (not shown). The side portions 320 and the extended areas 322 are also shown in FIG. 4. The bottom portion 324 of the frame of the cradle is shown and includes a bottom port 332 (e.g., headphone jack) and a raised bottom portion 333. As mentioned and described above in relation to FIG. 3A, the back portion 314, the side portions 320, and the bottom portion 324 together define an open space for receiving a wireless device.

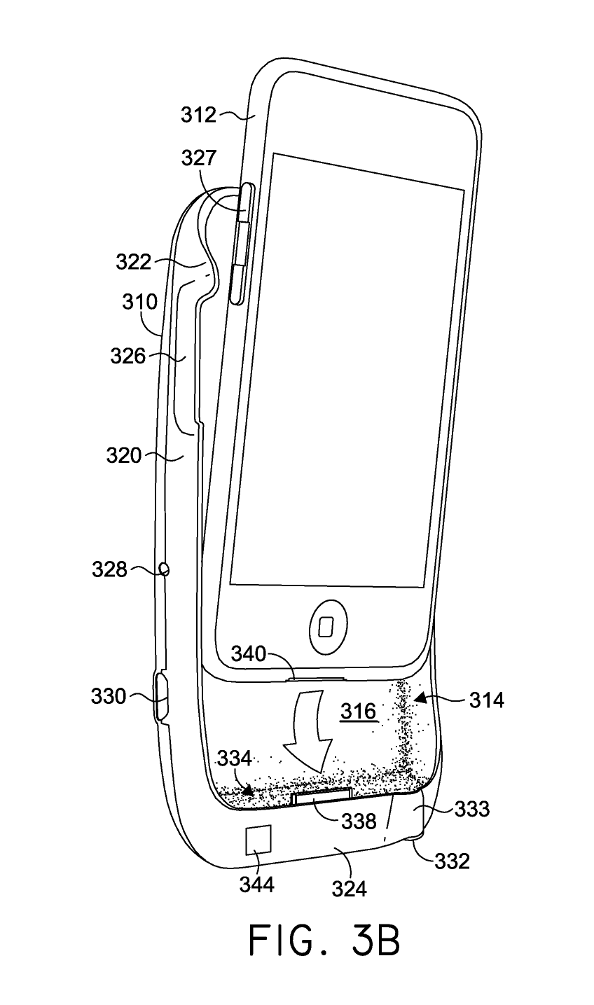

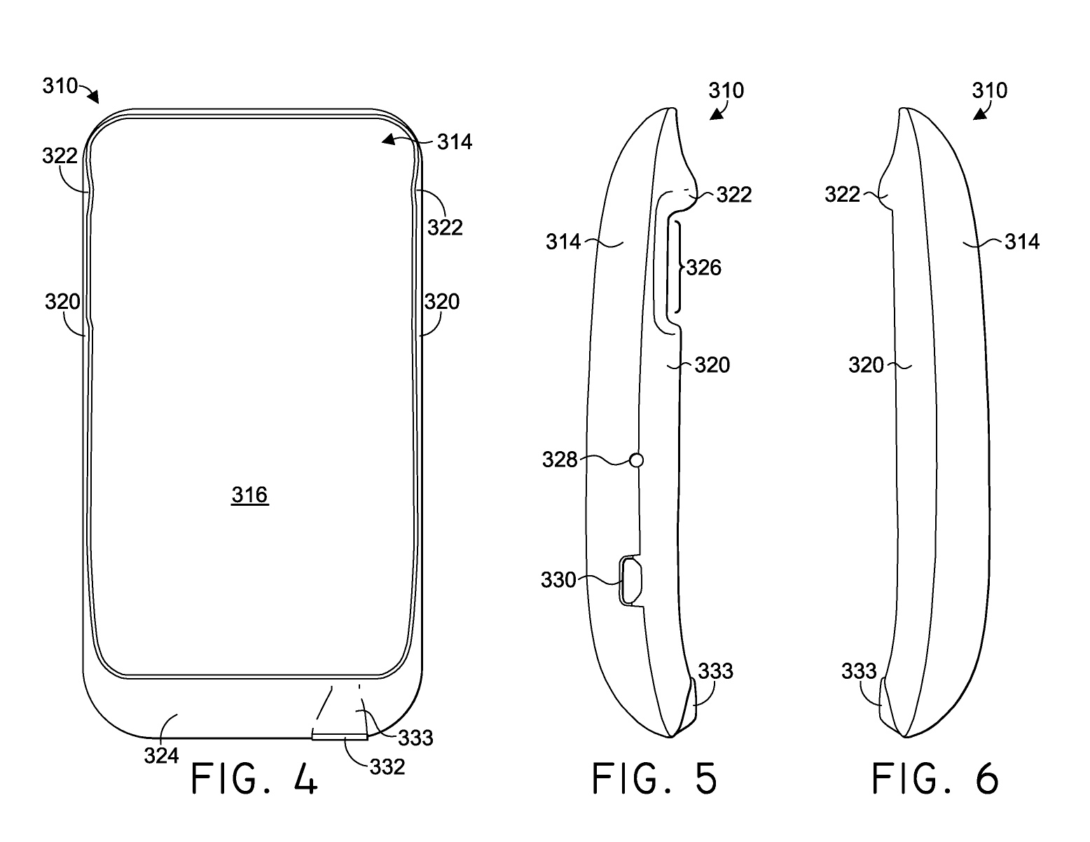

FIG. 5 depicts a first side view of a cradle for receiving a wireless device, in accordance with an embodiment of the present invention. The first side view of a side portion 320 of the cradle 310 illustrates an extended area that protrudes from the cradle 310. A recessed portion creates a volume control opening 326 that exposes a portion of a side of the wireless device when the wireless device is received by the cradle 310. The first side view also illustrates a reset button 328 and a USB port 330, which may be located on both a portion of the side portion 320 and a portion of the back portion 314, as shown in FIG. 5.

Referring to FIG. 6, a second side view of a cradle for receiving a wireless device is illustrated, in accordance with an embodiment of the present invention. The second side view illustrates a side portion 320, a back portion 314, and a raised bottom portion 333 that surrounds the bottom port (not shown). The side portion 320 has an extended area 322 that may help to hold the wireless device into place when it is received into the cradle 310.

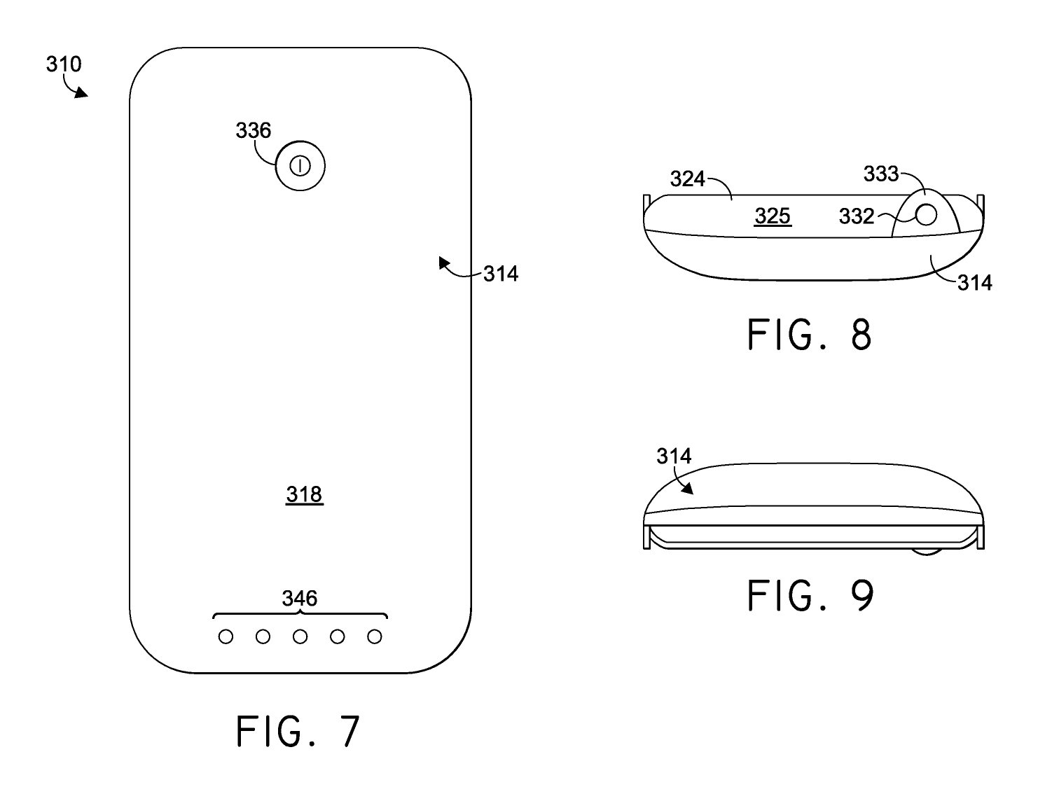

Turning now to FIG. 7, a rear view of a cradle for receiving a wireless device is illustrated, in accordance with an embodiment of the present invention. The rear view shows the back portion 314 of the cradle 310, and the outside back surface 318 of the back portion 314. A power button 336 is shown, which allows a user to turn on and off power to the cradle 310. A signal display 346 is also shown on the outside back surface 318 of the back portion 314. The signal display 346 provides a visual indication (e.g., by way of lighted areas) as to the current signal strength, such as between the cradle 310 and a BTS or cell tower. For instance, if all of the areas in the signal display 346 are lit, the current signal strength is high. Optionally, in one embodiment, the back portion 314 of the cradle 310 may include a camera hole that allows for a camera lens in the wireless device to be exposed through the cradle.

Referring to FIG. 8, a bottom view of a cradle for receiving a wireless device is shown, in accordance with an embodiment of the present invention. The bottom view of the cradle 310 illustrates the bottom portion 324 and the underneath surface of the bottom portion 325. The bottom port 332 and the raised bottom portion 333 are also shown. A top view of a cradle for receiving a wireless device is shown in FIG. 9, in accordance with an embodiment of the present invention. FIG. 9 illustrates the top of the cradle 310, and shows a portion of the back portion 314 of the cradle 310 as well.

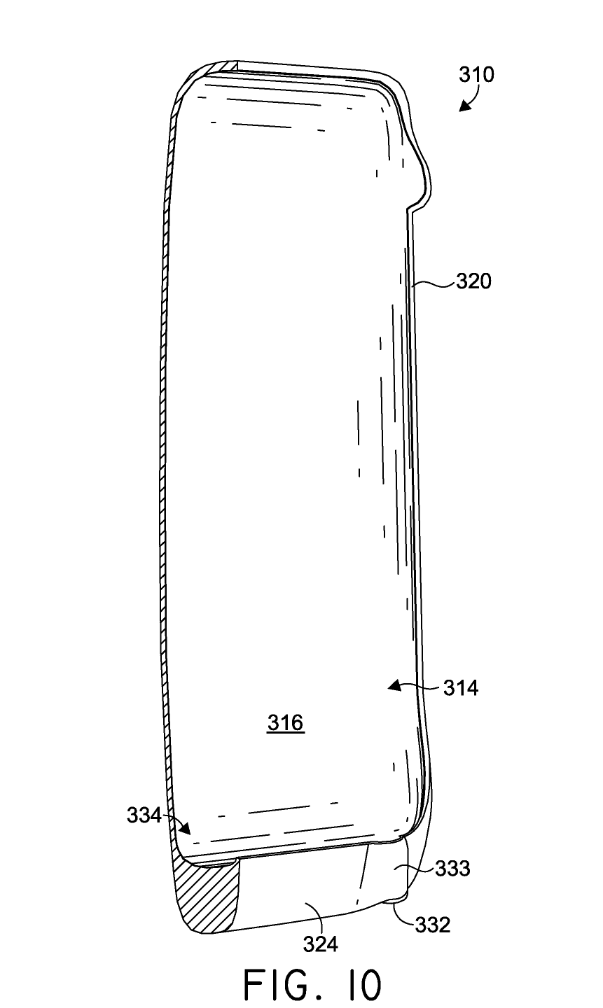

Referring now to FIG. 10, it depicts a cutaway view of a cradle for receiving a wireless device, in accordance with an embodiment of the present invention. The cutaway view illustrates the back portion 314 of the cradle 310 and the inside back surface 316 of the back portion 314. Further, a side portion 320 and a bottom portion 324 are also shown. On the bottom portion is the bottom port 332 and the raised bottom portion 333. The back portion 314, the side portions 320, and the bottom portion 324, together, define an open space 334 (e.g., void) for receiving a wireless device, such as the wireless device 312 illustrated in FIG. 3A.

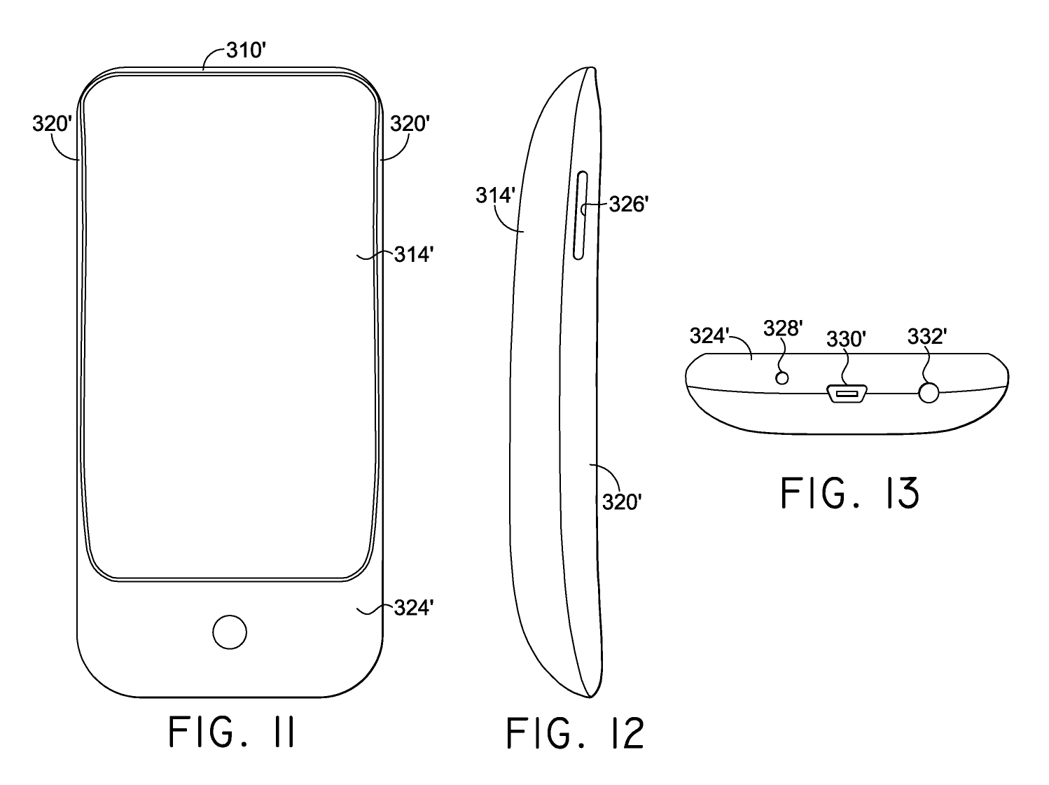

FIG. 11 depicts a front view of a cradle for receiving a wireless device, in accordance with another embodiment of the present invention. The cradle shown in FIG. 11 is similar to the cradle shown in other figures. For instance the back portion 314′, the side portions 320′, and the bottom portion 324′ define an open space that allows for the wireless device to be received by the cradle 310′. Here, the side portions 320′ do not have extended areas (e.g., wings) as they do in other embodiments described herein, but instead are relatively straight. FIG. 12 is a side view of the cradle 310′ of FIG. 11 and illustrates better how extended areas are not present on the side portions 320′. The back portion 314′ of the cradle 310′ is also shown. A volume control opening 326′ is shown, but instead of having one open side and three sides surrounded by cradle material, the volume control opening 326′ is completely surrounded by cradle material on each of its four sides, yet the volume control of the wireless device is still exposed so that even when the cradle 310′ is physically attached to the wireless device, the user is able to control the volume.

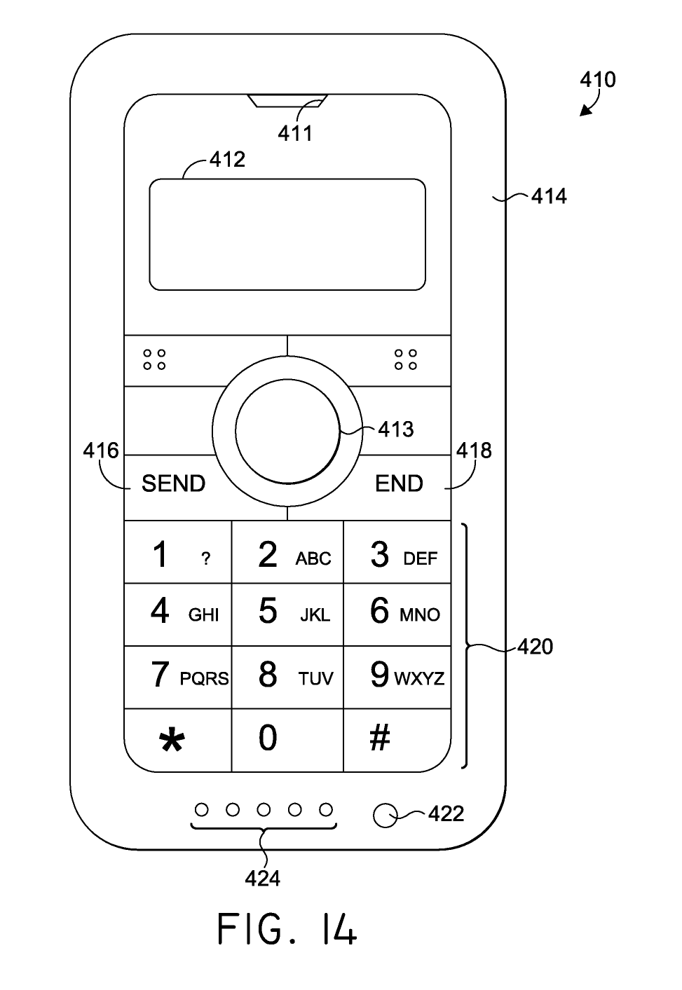

Referring to FIG. 13, a bottom view of a cradle for receiving a wireless device is illustrated, in accordance with an embodiment of the present invention. Unlike other embodiments of the present invention described herein, the bottom portion 324′ of the cradle 310′ in FIG. 13 includes the reset button 328′ and the USB port 330′, as well as the bottom port 332′ on the bottom of the cradle 310′. Other embodiments include the reset button 328′ and the USB port 330′ on the side and/or back portions of the cradle. As mentioned, the reset button, USB port, bottom port (e.g., headphone jack), power button, and any other ports/buttons on the cradle may be located on any portion of the cradle, even if not specifically shown or described herein.

FIG. 14 depicts an alternate embodiment of the invention, which provides for a mobile telecommunications device to be included as a portion of the cradle. Here, a rear view of a cradle with additional functionality is shown, in accordance with an embodiment of the present invention. The cradle 410 has a back portion 414 that has various components, as shown in FIG. 14. In one embodiment, the inside back surface would look similar to that shown in FIG. 4 and would still allow for a wireless device to be received into an open space defined by the back portion 414, side portions, and a bottom portion. The various features shown in the embodiment of FIG. 14 include a microphone/speaker 411, a display 412 (e.g., LCD screen), a tracking device 413, a send button 416, an end button 418, a keypad 420, a power button 422, and a signal display 424. In one embodiment, item 411 is just a microphone, as sound may be output through the wireless device as opposed to the cradle 410. For instance, when a telephone call is in progress, the audio received at the cradle/wireless device may be output from a speaker associated with the wireless device. In another instance, the cradle 410 may have a speaker of its own. Here, the wireless device may not even be involved at all with the operation of telephone calls other than being physically attached to the wireless device. Here the physical attachment between the wireless device and the cradle 410 provides the user with a convenient way to have access to both data and voice services when needed. A microphone 411 is provided to take inputted audio and allow the audio to be received by another mobile device capable of wirelessly communicating with the wireless device/cradle. The other features are typically found on standard telecommunication devices such as mobile phones. In one embodiment, the power button 422 may power just the cradle, and not the wireless device. Further, the signal display 424 provides an indication to the user as to the amount of signal associated with the cradle at a particular time.

In one embodiment, the cradle shown and described in relation to FIG. 14 may function as a stand-alone device such that even if it is not in physical contact with the wireless device, it may function as intended, and may even function in the same way as it would if it was in physical contact with the wireless device. The cradle would handle all inbound signaling requests for services such as short message service (SMS), global positioning service (GPS), and voice. Alternatively, data, voice, and GPS information can be passed along to the wireless device from the cradle either through a mechanical/electrical connection, as shown in FIG. 3B, or through a wireless connection (e.g., Wi-Fi), as shown in FIG. 3A. In yet another embodiment, the user may detach the cradle from the wireless device to accept and participate in an incoming telephone call.

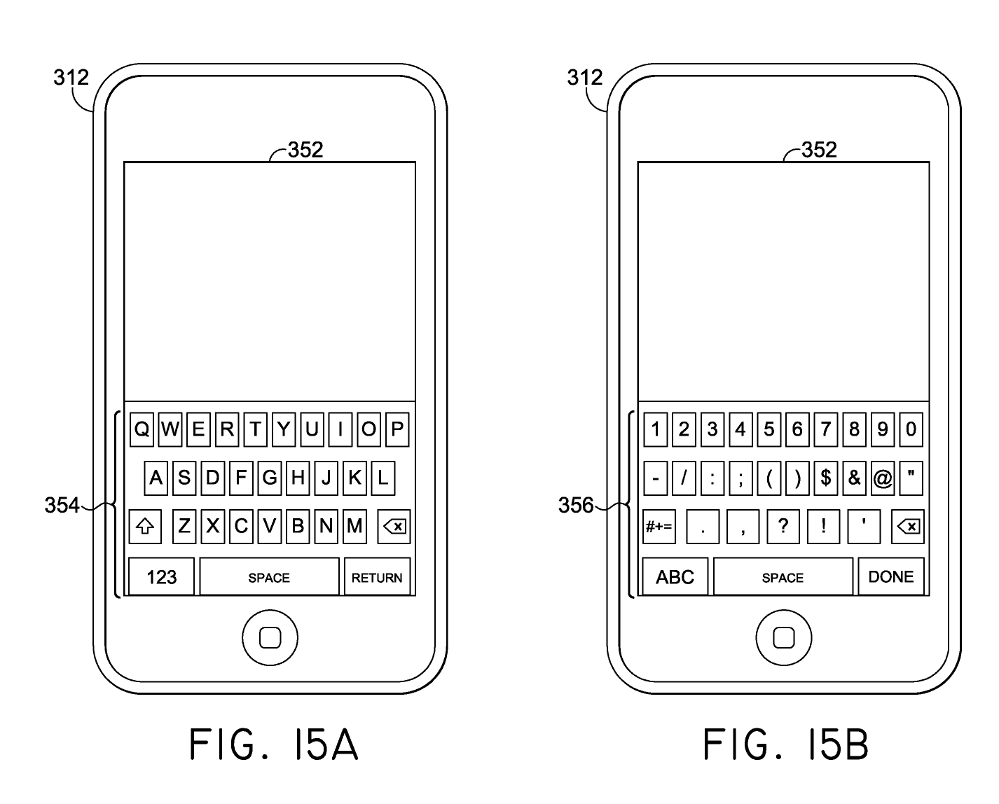

FIG. 15A depicts an interface of a wireless device having a touch screen, in accordance with an embodiment of the present invention. In embodiments of the present invention, voice services are provided to the wireless device, but without the use of a separate mobile communications device, as described above in relation to FIG. 14. For instance, a software application may be downloaded to the wireless device and used to provide a keypad and/or keyboard on the wireless device's display screen. The user would simply touch the numbers, letters, or other characters that the user wishes to input. For instance, a numeric keypad with numbers may appear when the user wishes to make a telephone call. Or, an alphanumeric keypad, such as a keyboard, may appear when the user sends a text message (e.g., SMS). In the case of GPS, the user may need a keyboard to enter a destination address so that the GPS can calculate distances, directions, etc., from the user's current location, for example.

Specifically, the embodiment of FIG. 15A includes a wireless device 312 having a display 352 and a keyboard 354 that allows a user to use the touch capabilities of the wireless device 312 and touch each alphanumeric character to input that character into a text message or other application, for example. The embodiment of FIG. 15B is similar to that of FIG. 15A in that it also illustrates a wireless device 312 having a display 352 and a keypad 356 on the display 352. The keypad 356 shown here includes numeric characters as well as other normumeric characters. In further embodiments, a CDMA chipset and a microphone may be added to the wireless device 312 so that voice calls can be placed.

Many different arrangements of the various components depicted, as well as components not shown, are possible without departing from the scope of the claims below. For instance, while the cradle is illustrated in various figures as having extended areas (e.g., wings) that extend from the side portions of the cradle, these extended areas may not be included in one embodiment of the cradle. Or, the extended areas may wrap around the front of the wireless device when the wireless device has been received by the cradle. Also, while a volume control opening in the cradle has been described above, the opening, instead of having three sides and one open end may have four sides and no open ends such that this area is surrounded by material that comprises the cradle. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. A cradle for receiving a wireless device, the cradle enabling the wireless device to communicate with a wireless communications network, the cradle comprising:
a frame comprising:
a back portion,
side portions, and
a bottom portion onto which a bottom end of the wireless device is placed, wherein the back portion, the side portions, and the bottom portion define an open space that receives the wireless device such that when the wireless device is placed into the open space, the wireless device stays in place relative to the frame thus remaining in direct contact with the cradle; and
a first wireless communication component that facilitates wireless communication between the wireless device and the wireless communications network.

2. The cradle of claim 1, further comprising a battery.

3. The cradle of claim 2, wherein the cradle shares power resources from the battery with the wireless device.

4. The cradle of claim 1, wherein the cradle receives power resources from the wireless device.

5. The cradle of claim 1, wherein the first wireless communication component is a radio.

6. The cradle of claim 1, wherein one or more of the back portion, the side portions, or the bottom portion of the frame include one or more of:
a headphone jack;
a USB port;
a reset button;
a power button; or
an opening that exposes a portion of a side end of the wireless device that provided volume control to the wireless device.

7. The cradle of claim 1, wherein the first wireless component facilitates long-range signaling between the cradle and the wireless communications network, and wherein the long-range signaling includes one or more of CDMA, GPRS, TDMA, GSM, WIMAX, LTE, 3G, or 4G.

8. The cradle of claim 1, wherein the first wireless communication component is configured for both short-range signaling and long-range signaling.

9. The cradle of claim 1, further comprising a second wireless communication component that is configured for short-range signaling with the wireless device, wherein the short-range signaling uses 802.11.

10. The cradle of claim 9, wherein data is communicated from the wireless device to the cradle by way of the first wireless communications component and the data is communicated from the cradle to the wireless communications network by way of the second wireless communications component.

11. The cradle of claim 1, wherein the wireless device is a Wi-Fi-capable device capable of short-range signaling with the cradle.

12. A cradle for receiving a wireless device, the cradle enabling the wireless device to communicate with a wireless communications network, the cradle comprising:
a frame comprising:
a back portion,
side portions, and
a bottom portion comprising a connector element for engaging a bottom connector of the wireless device such that the cradle and the wireless device are mechanically and electrically connected thus enabling communication between the cradle and the wireless device, wherein the back portion, the side portions, and the bottom portion of the frame define an open space for receiving the wireless device; and
a wireless communication component that facilitates long-range signaling between the cradle and the wireless communications network.

13. The cradle of claim 12, wherein data is communicated from the wireless device to the cradle by way of the engaging of the connector element and bottom connector of the wireless device and the data is communicated from the cradle to the wireless communications network by way of the wireless communication component.

14. The cradle of claim 12, wherein the bottom portion is sized such that it houses the wireless communication component.

15. The cradle of claim 12, further comprising one or more of:
a headphone jack;
a USB port;
a power button; or
a reset button.

16. A cradle for receiving a wireless device, the cradle enabling the wireless device to communicate with a wireless communications network, the cradle comprising:
a frame comprising:
a back portion,
left and right side portions, and
a bottom portion, wherein the back portion, the left and right side portions, and the bottom portion define a space into which the wireless device is received such that the wireless device is held in place relative to the cradle and remains in close proximity to the cradle until the wireless device is removed from the cradle;
a first wireless connection component that facilitates short-range signaling between the wireless device and the cradle such that data is communicated between the wireless device and the cradle by way of the first wireless connection component; and
a second wireless connection component that facilitates long-range signaling between the cradle and the wireless communications network such that the data is communicated from the cradle to the wireless communications component by way of the second wireless connection component.

17. The cradle of claim 16, wherein the first wireless connection component and the second wireless connection component are located in the bottom portion of the frame.

18. The cradle of claim 16, wherein one of the left or the right side portions includes an opening that exposes a portion of a side end of the wireless device.

19. The cradle of claim 18, wherein the portion of the side end of the wireless device is a volume control.

20. The cradle of claim 16, wherein the wireless device is a Wi-Fi-capable device.
